(19) United States
(12) Patent Application Publication
(10) Pub. No.: US 2022/0232338 A1
(43) Pub. Date: Jul. 21, 2022

(54) INFORMATION PROCESSING APPARATUS, INFORMATION PROCESSING METHOD, AND PROGRAM

(71) Applicant: SONY GROUP CORPORATION, TOKYO (JP)

(72) Inventors: NAOYA TAKAHASHI, TOKYO (JP); YU MAENO, TOKYO (JP)

(21) Appl. No.: 17/614,094

(22) PCT Filed: Apr. 9, 2020
(86) PCT No.: PCT/JP2020/016028

§ 371 Date: Nov. 24, 2021

(30) Foreign Application Priority Data
Jun. 5, 2019 (JP) 2019-105037

(51) Int. Cl. H04S 7/00; H04R 5/02; H04R 5/04; B64C 39/02; B64D 47/02

(52) U.S. Cl. CPC H04S 7/302; H04R 5/02; H04R 5/04; B64C 39/024; B64C 2201/12; H04S 2420/13; H04S 2400/13; B64C 2201/027; B64D 47/02

(57) ABSTRACT

Provided is an information processing apparatus having an audio signal generation unit which generates an audio signal reproduced from a loudspeaker on the basis of position information of each of a plurality of unmanned aerial vehicles, each of the unmanned aerial vehicles having the loudspeaker.

### TECHNICAL FIELD

The present disclosure relates to an information processing apparatus, an information processing method, and a program.

### BACKGROUND ART

In accordance with improvement of an acoustic reproduction technology in recent years, there have been proposed a variety of technologies which reproduce sound fields. For example, in the below-mentioned Non-Patent Document 1, a technology relating to vector base amplitude panning (VBAP) is described. The VBAP is a method in which when a virtual sound source (virtual sound image) is reproduced by three loudspeakers in proximity to one another, gains are determined such that a direction of a synthetic vector obtained by weighting and adding three directional vectors spanning from a listening position toward the loudspeakers by gains imparted to the loudspeakers matches a direction of the virtual sound source. Besides this, there have been proposed technologies and the like which are referred to as wavefront synthesis and higher order ambisonics (HOA).

### CITATION LIST

### Patent Document

Non-Patent Document 1: Ville Pulkki, “Virtual Sound Source Positioning Using Vector Base Amplitude Panning”, Journal of the Audio Engineering Society vol. 45, Issue 6, pp. 456-466 (1997)

### SUMMARY OF THE INVENTION

### Problems to be Solved by the Invention

However, the technology described in Non-Patent Document 1 or the like presupposes that the loudspeakers which reproduce sound are fixed onto a surface of the ground or the like. Accordingly, a system in which a sound field is formed by using loudspeakers which are not fixed to the surface of the ground or the like has a problem in that these technologies cannot be applied to the system as they are.

One of objects of the present disclosure is to provide an information processing apparatus, an information processing method, and a program, each of which is applicable to the system which forms the sound field by using the loudspeakers which are not fixed to the surface of the ground or the like.

### Solutions to Problems

The present disclosure is, for example, an information processing apparatus including

an audio signal generation unit which generates an audio signal reproduced from a loudspeaker on the basis of position information of each of a plurality of unmanned aerial vehicles, each of the unmanned aerial vehicles having the loudspeaker.

In addition, the present disclosure is, for example, an information processing method including

generating, by an audio signal generation unit, an audio signal reproduced from a loudspeaker on the basis of position information of each of a plurality of unmanned aerial vehicles, each of the unmanned aerial vehicles having the loudspeaker.

In addition, the present disclosure is, for example, a program which causes a computer to execute an information processing method including

generating, by an audio signal generation unit, an audio signal reproduced from a loudspeaker on the basis of position information of each of a plurality of unmanned aerial vehicles, each of the unmanned aerial vehicles having the loudspeaker.

### BRIEF DESCRIPTION OF DRAWINGS

FIG. 1 is a diagram illustrating a configuration example of a reproduction system according to an embodiment.

FIG. 2 is a block diagram illustrating a configuration example of each of a UAV and a master device according to the embodiment.

FIG. 3 is a diagram which is referenced when one example of processing performed by an audio signal generation unit according to the embodiment is described.

FIG. 4 is a diagram which is referenced when one example of processing performed by the audio signal generation unit according to the embodiment is described.

FIG. 5 a diagram schematically illustrating one example of a reproduced sound field.

FIG. 6 is a diagram which is referenced when one example of a GUI according to the embodiment is described.

### MODE FOR CARRYING OUT THE INVENTION

Hereinafter, with reference to the accompanying drawings, an embodiment and the like of the present disclosure will be described. Note that the description will be given in the following order.
<Problem to be Considered>
<Embodiment>
<Modified Example>

The below-described embodiment and the like are favorable specific examples of the present disclosure and contents of the present disclosure are not limited to the embodiment and the like.

### Problem to be Considered

In order to facilitate understanding of the present disclosure, first, a problem which should be considered in the embodiment of the present disclosure is described. In the embodiment of the present disclosure, the description will be given by citing a system, as an example, in which a plurality of unmanned flying objects (hereinafter, appropriately referred to as unmanned aerial vehicles (UAVs) is used and audio signals are reproduced from the UAVs, thereby forming a desired sound field. In this system, there is a case where when sound is reproduced by performance or the like by using the plurality of UAVs, it is desired that a sound field is reproduced in accordance with movement of the UAVs. At this time, there is a case where it is preferable that an incoming direction of the sound is from midair where the UAVs are present. However, for example, since positions where loudspeakers can be installed are limited, it is often the case that a desired sense of localization is hardly obtained. For this problem, although it is considered that the loudspeakers are mounted on the UAVs themselves to reproduce the sound, in this case, since it is difficult to obtain accurate positions of the loudspeakers and the positions thereof temporally change, even if the above-mentioned technology is simply applied, it is highly likely that the desired sound field cannot be obtained. Therefore, in the present embodiment, for example, on the basis of position information of the UAVs which change in real time, audio signals assigned from the loudspeakers which the UAVs have are reproduced, thereby realizing the desired sound field, Hereinafter, the present embodiment will be described in detail.

### Embodiment

### [Configuration Example of Reproduction System]

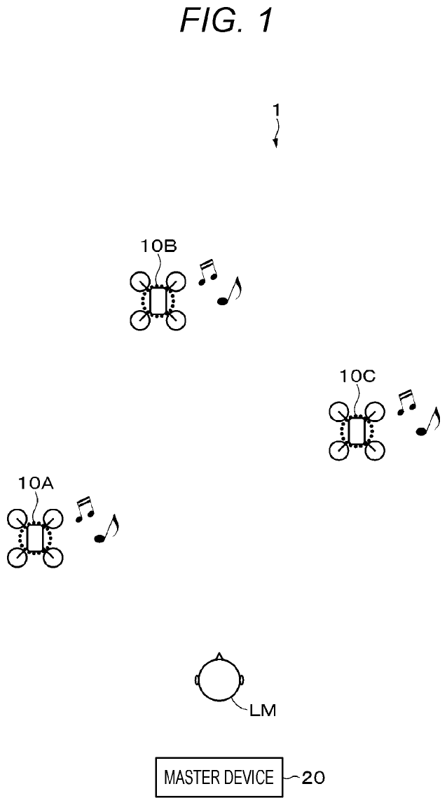

FIG. 1 is a diagram illustrating a configuration example of a reproduction system (reproduction system 1) according to an embodiment of the present disclosure. The reproduction system 1 has, for example, a plurality of UAVs and a master device 20 as one example of an information processing apparatus. The UAVs fly autonomously or in accordance with user control.

In FIG. 1, three UAVs (UAVs 10A, 10B and 10C) are illustrated. A number of the UAVs in the reproduction system 1 is not limited to three and can be appropriately set, and the number of the UAVs can vary in real time. Note that in a case where it is not required to discern the individual UAVs, the UAVs are collectively called a UAV 10.

The master device 20 is, for example, a personal computer or a smartphone. The master device 20 generates audio signals reproduced from the UAV 10. Then, the master device 20 supplies the generated audio signals to the UAV 10. The master device 20 supplies the audio signals to the UAV 10, for example, by using wireless communication.

In an example illustrated in FIG. 1, the master device 20 generates the audio signals reproduced from the UAV 10A and supplies the generated audio signals to the UAV 10A. In addition, the master device 20 generates audio signals reproduced from the UAV 10B and supplies the generated audio signals to the UAV 10B. In addition, the master device 20 generates audio signals reproduced from the UAV 10C and supplies the generated audio signals to the UAV 10C. Each UAV reproduces the audio signals supplied from the master device 20 from a loudspeaker which each UAV itself has. The audio signals are reproduced from the UAV 10, thereby reproducing a desired sound field for a listener LM.

### [Configuration Example of UAV and Master Device]

### (Configuration Example of UAV)

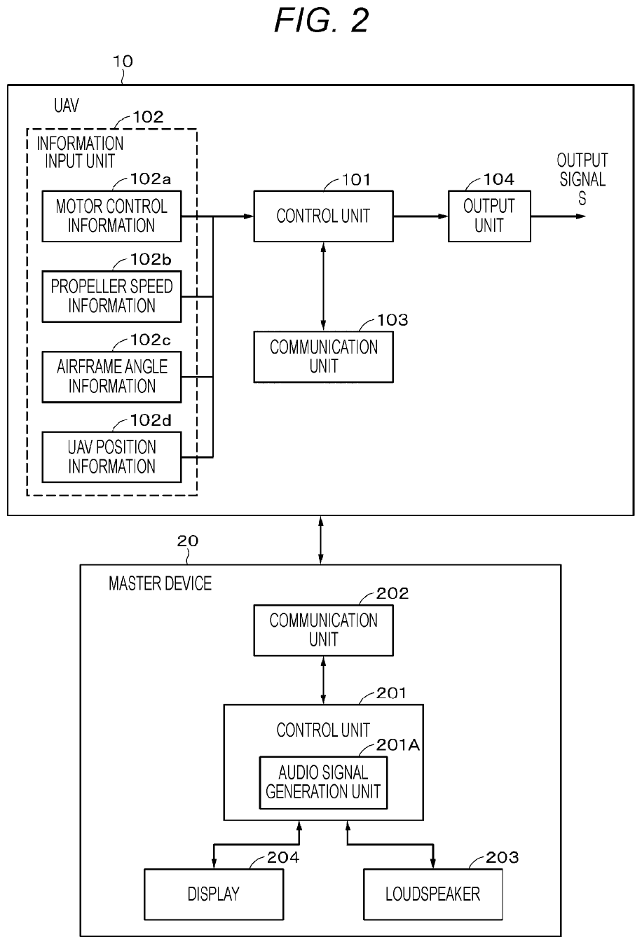

FIG. 2 is a block diagram illustrating a configuration example of the UAV 10 and the master device 20. The UAV 10 has, for example, a control unit 101, an information input unit 102, a communication unit 103, and an output unit 104.

The control unit 101 is constituted of a central processing unit (CPU) or the like and comprehensively controls the whole UAV 10. The UAV 10 has a read only memory (ROM) in which a program executed by the control unit 101 is stored, a random access memory (RAM) used as a work memory upon executing the program, and the like (illustration of these is omitted).

The information input unit 102 is an interface to which various kinds of information are inputted from sensors (not illustrated) which the UAV 10 has. As specific examples of the information inputted to the information input unit 102, motor control information 102a for driving a motor, propeller control information 102b for controlling a propeller speed of the UAV 10, and airframe angle information 102c which indicates an angle of an airframe of the UAV 10 are cited.

In addition, as the information inputted to the information input unit 102, UAV position information 102d which is position information of the UAV 10 is cited. As the sensors for acquiring the UAV position information, stereo vision, a distance sensor, an atmospheric pressure sensor, image information captured by a camera, a global positioning system (GPS), distance measurement by inaudible sound, and a combination of these, and the like are cited. These sensors are used and the heretofore known method is employed, thereby acquiring the position information of the UAV 10 to be inputted to the information input unit 102.

The communication unit 103 is configured to communicate with devices which are present on the surface of the ground and a network, other UAVs, and the like in accordance with control performed by the control unit 101. Although the communication may be performed in a wired manner, in the present embodiment, wireless communication is supposed. As the wireless communication, a local area network (LAN), Bluetooth (registered trademark), Wi-Fi (registered trademark), a wireless USB (WUSB), or the like is cited. Via the above-mentioned communication unit 103, the above-described UAV position information is transmitted from the UAV 10 to the master device 20. In addition, via the above-mentioned communication unit 103, the audio signals transmitted from the master device 20 are received by the UAV 10.

The output unit 104 is a loudspeaker which outputs the audio signals. The output unit 104 may include an amplifier or the like which amplifies the audio signals. For example, the control unit 101 subjects the audio signals received by the communication unit 103 to predetermined processing (decompression processing or the like) and thereafter, the processed audio signals are reproduced from the output unit 104. Note that for the output unit 104, an appropriate configuration such as a single loudspeaker and a loudspeaker array having radial arrangement can be adopted. Note that in the below description, there may be a case where a loudspeaker which the UAV 10A has is referred to as a loudspeaker 104A, a loudspeaker which the UAV 10B has is referred to as a loudspeaker 104B, a loudspeaker which the UAV 10C has is referred to as a loudspeaker 104C, and a loudspeaker which the UAV 10D has is referred to as a loudspeaker 104D.

Note that the UAV 10 may have a configuration which is different from the above-described configuration. For example, the UAV 10 may have a microphone or the like, which measures sound on the surface of the ground.

### (Configuration Example of Master Device)

The master device 20 has, for example, a control unit 201, a communication unit 202, a loudspeaker 203, and a display 204. The control unit 201 has an audio signal generation unit 201A as a function thereof.

The control unit 201 is constituted of a CPU or the like and comprehensively controls the whole master device 20. The audio signal generation unit 201A which the control unit 201 has generates audio signals corresponding to each of the UAVs.

The communication unit 202 is configured to communicate with the UAV 10. Via the above-mentioned communication unit 202, the audio signals generated by the audio signal generation unit 201A are transmitted from the master device 20 to the UAV 10.

The loudspeaker 203 outputs audio signals processed by the UAV 10 and appropriate audio signals. In addition, the display 204 displays various pieces of information.

The master device 20 may have a configuration which is different from the above-described configuration. For example, although in the above-described example, the UAV 10 acquires the position information (UAV position information) thereof, the UAV position information may be acquired by the master device 20. Then, the master device 20 may have various kinds of sensors for acquiring the UAV position information. Note that the acquisition of the UAV position information includes observation of a position of each of the UAVs or estimation of the UAV position thereof based on a result of the observation.

### [Example of Processing of Master Device]

Subsequently, an example of processing performed by the master device 20, specifically, an example of processing performed by the audio signal generation unit 201A which the master device 20 has will be described. On the basis of the position information of each of the plurality of UAVs 10, the audio signal generation unit 201A generates audio signals reproduced from the output unit 104 which each of the UAVs 10 has.

### (First Processing Example)

The audio signal generation unit 201A determines driving signals of the loudspeakers for reproducing the desired sound field by utilizing the acquired UAV position information. The present example is an example in which as a sound field reproduction method, VBAP is applied.

For simplification, it is assumed that each of the UAVs (UAV 10A, 10B, and 10C) has one loudspeaker. Note that even in a case where each of the UAVs includes a plurality of loudspeakers, when a distance between the loudspeakers is sufficiently close, as compared with other loudspeakers of the other UAV 10, the loudspeakers may be treated as a single loudspeaker and driving thereof may be conducted by the same signal. In order to perform the processing according to the present example, the UAV 10A to 10C among the plurality of UAVs 10 which are present in a space are selected. As the three UAVs selected to perform the processing according to the present example, any three UAVs can be selected. In the present example, three UAVs (UAV 10A, 10B, and 10C) which are close to a position of a virtual sound source VS which is desired to be reproduced are selected.

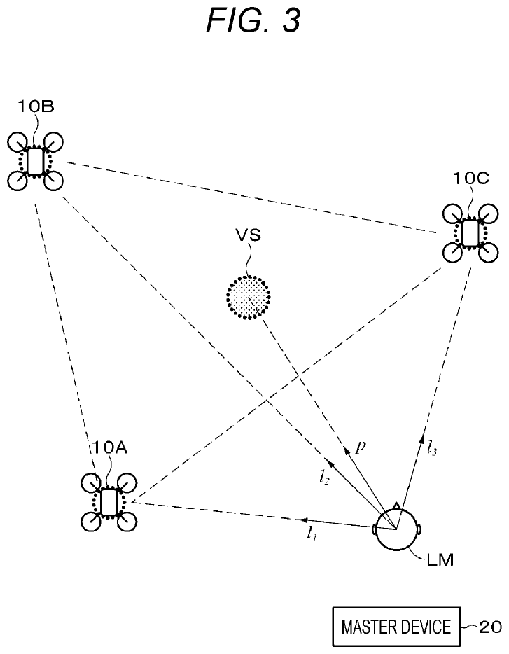

As illustrated in FIG. 3, in a case where a unit vector p which faces toward the virtual sound source VS is defined as

p∈R₃, and

unit vectors which surround the unit vector p and face toward the three loudspeakers are defined as

l₁, l₂, l₃ ∈R₃,

the three loudspeakers are selected in such a way that the unit vector p is included within a solid angle surrounded by l₁, l₂, and l₃. In the example illustrated in FIG. 3, the loudspeakers 104A to 104C which the UAV 10A to 10C respectively have are selected. In the present example, l₁, l₂, and l₃ and L (described later) based on these correspond to pieces of position information of the UAV 10A, 10B, and 10C. Note that a subscript numeral 1(first) corresponds to the UAV 10A, a subscript numeral 2 (second) corresponds to the UAV 10B, and a subscript numeral 3 (third) corresponds to the UAV 10C. In addition, in a case where subscript or superscript numeral “123” is described, the subscript or superscript numeral indicates values of gains or the like obtained on the basis of the UAVs 10A to 10C. In addition, it is indicated that the later-described subscript numeral 4 (fourth) corresponds to the later-described UAV 10D. Also as to other formulas described below, representation based on the similar prescription is made.

Next, the unit vector p can be represented in a linear combination of l₁, l₂, and l₃ as follows.

$${p}^{T} = {gL}_{123}$$

However,

$$g = ( {g}_{1} , {g}_{2} , {g}_{3} )$$

represents each loudspeaker gain, and

$$L = {( \text{?} )}^{T} . \\ \text{?} \text{indicates text missing or illegible when filed}$$

In the above formula, T represents a matrix or transposition of a vector.

The loudspeaker gain g can be obtained by using an inverse matrix from the following formula 1.

$$g = {p}^{T} {L}_{123}^{- 1} \qquad [ Formula 1 ]$$

Although in order for L₁₂₃ to have the inverse matrix, it is required for l₁, l₂, and l₃ to be linearly independent, because in the present example, it is supposed that the three loudspeakers are not located on one linear line, the inverse matrix of L₁₂₃ is invariably present. By normalizing the loudspeaker gain g, a gain of each of the loudspeakers can be obtained. The audio signal generation unit 201A performs calculation of the obtained loudspeaker gain of each of the loudspeakers for audio signals of the source. Then, the master device 20 transmits the audio signals after the calculation via the communication unit 202 to the UAV 10 having the corresponding loudspeaker.

Note that although it is supposed that in the VBAP, distances from a listening position (position where the listener LM is present) to the loudspeakers are equal, even in a case where the distances are not equal, by adding delay to each of the driving signals, the similar effect can be obtained in a quasi manner. A delay time can be obtained from Δlⁱ/c, where a difference between each of the distances and a distance of the loudspeaker which is most distant from the listener LM is Δlⁱ, but c represents sonic speed. However, c represents sonic speed.

Incidentally, since the UAV 10 is floating in midair, it is difficult to completely obtain an accurate position of the UAV 10. Furthermore, in a case where the UAV 10 moves, it is considered that accuracy at which the position of the UAV 10 is estimated is worsened in accordance with speed of the movement. Specifically, the higher the speed of the movement of the UAV 10 is, the larger a movement distance from a current time to a next time is and the larger an error in estimation of the position is. In a case where the error in the estimation of the position is large, even when the reproduction is performed by using the loudspeaker driving signals obtained by supposing ideal positions, the sound field cannot be correctly reproduced.

Accordingly, it is desirable that certainty of the position information of the UAV 10 be attained by the audio signal generation unit 201A of the master device 20, that is, processing in accordance with the error in the estimation of the position be performed by the audio signal generation unit 201A thereof. Specifically, it is desirable that driving signals of the loudspeakers in consideration of the error in the estimation of the position be set. For example, it is desirable that filters for obtaining the driving signals of the loudspeakers be regularized and are weighted in accordance with a magnitude of the error in the estimation of the position. Specifically, it is desirable that a weight which contributes to generation of the audio signals of the UAV 10 remaining still among the UAVs 10 which are equally distant from a target sound source be made larger than those of the UAVs 10 which are moving at high speed (UAV 10 whose error in the estimation of the position is large) since the error in the estimation of the position of the UAV 10 remaining still is small. Hereinafter, the processing in consideration of the error in the estimation of the position in the present example will be described.

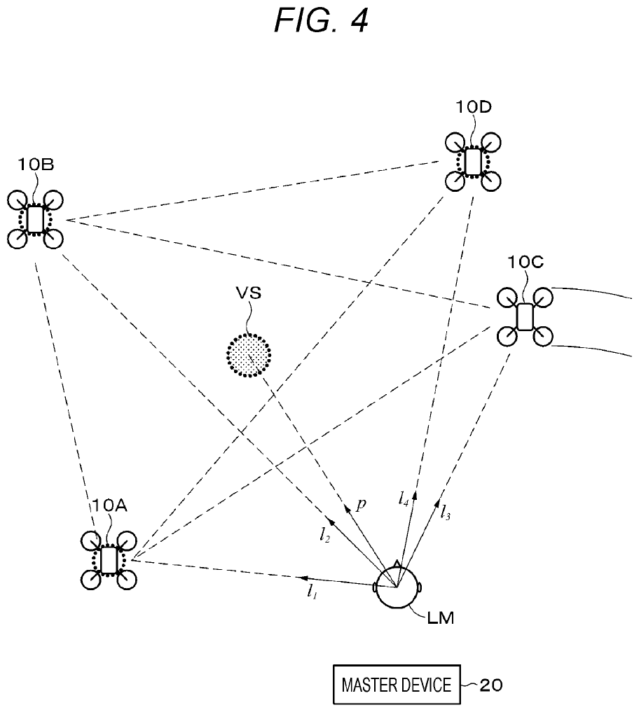

For example, as illustrated in FIG. 4, it is supposed that for a reason that the UAV 10C is moving or other reason, the error in the estimation of the position of loudspeaker 104C is large. In this case, when panning is performed by using the loudspeakers 104A, 104B, and 104C, a position of a sound image is deviated or moved. Therefore, by using a loudspeaker 104D (loudspeaker which a UAV 10D flying in the vicinity of UAV 10C has) which is close to the loudspeaker 104C and has an error in the estimation of the position, which allows the virtual sound source VS to be within the solid angle, L₁₂₄ is calculated and a normalized gain g₁₂₄ is obtained. By using the loudspeakers 104A, 104B, 104C, and 104D, a sound field can be finally reproduced. Each of the driving signals can be represented as a linear sum of g₁₂₃ and g₁₂₄. Specifically, it can be expressed by the following formula.

$$g = [ {g}_{1} {g}_{2} {g}_{3} {g}_{4} ] = λ [ {g}_{1}^{123} {g}_{2}^{123} {g}_{3}^{123} 0 ] + ( 1 - λ ) [ {g}_{1}^{124} {g}_{2}^{124} {g}_{4}^{124} ]$$

Here, λ can be defined as a function of the error in the estimation of the position on the basis of a previously conducted experiment or the like. For example, λ can be set to one when an error in the estimation of the position Δr is a certain threshold value Δrₘᵢₙ or less and to zero when the error in the estimation of the position Δr is Δrₘₐₓ or less.

Note that in a case where all of the positions of the UAVs 10 associated with the reproduction of the virtual sound source similarly include the errors, several combinations of the UAVs which allow the virtual sound source VS to be included in the solid angle are determined and an average thereof is taken, thereby allowing averagely correct direction information to be presented.

### (Second Processing Example)

The audio signal generation unit 201A determines driving signals of loudspeakers which reproduce a desired sound field by utilizing acquired UAV position information. The present example is an example in which as the sound field reproduction method, HOA is applied.

When a mode domain coefficient of the desired sound field is defined as follows

aₙ^{m}(ω),

a reproduction signal D₁(ω) of the l-th loudspeaker which reproduces the desired sound field can be represented by the following formula 2.

$$D \text{?} ( ω ) = \frac{1}{2 π {R}^{2}} {\sum }_{n = 0}^{N} {\sum }_{m = - n}^{n} \sqrt{\frac{2 n \text{?}}{4 π}} \frac{{a}_{n}^{m} ( ω )}{G \text{?}} {Y}_{n}^{m} ( θ \text{?} , φ \text{?} ) \\ \text{?} \text{indicates text missing or illegible when filed} \qquad [ Formula 2 ]$$

However, each of (r₁, θ₁, ϕ₁) in Formula 2 indicates a distance from the origin to the l-th loudspeaker (The speaker may be referred to as a loudspeaker l.), an elevation angle, and an azimuth angle, which correspond to the position information in the second processing example.

In addition,

Yₙ^{m}

represents spherical harmonics, and m and n are HOA orders.

In addition,

Gₙ^{m}

is an HOA coefficient of a transfer function of a loudspeaker, and in a case where the loudspeaker is a point sound source, the HOA coefficient can be represented by the following formula.

$${G}_{n}^{m} ( r \text{?} , ω ) = - {ikh}_{n}^{( 2 )} ( kr \text{?} ) {Y}_{n}^{m} ( 0 , 0 )$$

$$\text{?} \text{indicates text missing or illegible when filed}$$

However,

hₙ⁽²⁾

is a ball Hankel function of the second kind.

Also in the present example, processing in consideration of an error in estimation of a position can be performed. There may be a case where the processing described below is referred to as a mode matching since the processing is to match modes of HOA.

In the later-described multi-point control (an example in which a plurality of control points is present), a sound field excluding the control points is not considered, and there is a problem in that it is required to determine arrangement of optimum control points. On the other hand, in a method of the mode matching, by performing conversion to a mode region and aborting an expansion coefficient at an appropriate order, a range with one control point as a center can be averagely controlled.

A desired sound field is defined as p(r) and a transfer function G(r|rₗ) from the loudspeaker l to a point r within a control region is expanded by a prescribed function shown below.

$${φ}_{n}^{m} ( r ) = {j}_{n} ( kr ) {Y}_{n}^{m} ( θ , ψ )$$

The desired sound field p(r) and the transfer function G(r|rₗ) can be represented by using expansion coefficients

bₙ^{m}, c_{n,l}^{m}

as

$$G ( r \vert r \text{?} ) = {\sum }_{n = 0} \text{?} {\sum }_{m = - n}^{n} c \text{?} {φ}_{n}^{m} ( r )$$

$$p ( r ) = {\sum }_{n = 0} \text{?} {\sum }_{m = - n}^{n} b \text{?} {φ}_{n}^{m} ( r ) , \\ \text{?} \text{indicates text missing or illegible when filed}$$

respectively.

Here, when the expansion is aborted at the Nth order, relationship between a reproduced sound field in a mode region and a driving signal of the loudspeaker can be represented as follows

Cd=b (b represents a desired sound field in the mode region),

but

$$C = [ \begin{matrix}{c}_{0 , 1}^{0} & ⋯ & {c}_{0 , L}^{0} \\ ⋮ & ⋱ & ⋮ \\ {c}_{N , 1}^{N} & ⋯ & {c}_{N , L}^{N}\end{matrix} ] , b = [ \begin{matrix}{b}_{0}^{0} \\ ⋮ \\ {b}_{N}^{N}\end{matrix} ] .$$

A pseudo inverse matrix of C is obtained, thereby allowing the driving signal of the loudspeaker corresponding to each of the UAVs to be obtained. However, as described above, in a case where the error in the estimation of the position of the loudspeaker which the l-th UAV has is large, it is anticipated that an error in sound field reproduction by a driving signal dₗ of the l-th loudspeaker is large. Therefore, it is desirable that contribution made by dₗ be decreased. In order to decrease the contribution of dₗ, a regularization term (regularization component) is added to the driving signal as shown below.

$$\hat{d} = arg {min}_{d} {\vert b - Cd \vert}^{2} + λ {\vert Ad \vert}^{2}$$

Here, λ is a parameter which determines strength of regularization, and A represents a diagonal matrix which has a weight aₗ, which determines relative strength of the regularization for the loudspeaker l, as a diagonal component.

A solution of this optimization problem is obtained as shown below.

$$\hat{d} = {( {C}^{R} C + λ A )}^{- 1} {C}^{H} b$$

As described above, the audio signal generation unit 201A can generate the audio signals in consideration of the error in the estimation of the position.

Note that for example, by performing the above-described first and second processing examples, it is made possible to reproduce various sound fields (sound images).

### (Third Processing Example)

The present example is an example in which sound field reproduction is performed by multi-point control in which driving signals of loudspeakers at a plurality of control points are obtained. The control points are previously set positions. In addition, a transfer function from a position of a loudspeaker up to the control points can be obtained by previous measurement or by assumption of a free space and approximation by using a green function.

When sound pressure at a control point i is defined as pᵢ, a transfer function from a loudspeaker l to the control point i, which is position information in the present example, is defined as Gᵢₗ, and a loudspeaker driving signal of the loudspeaker l is defined as dₗ, and the following is defined,

$$P = [ p \text{?} , … , p \text{?} ] \text{?} , \\ D = {[ d \text{?} , … , d \text{?} ]}^{T} , \\ G = [ G \text{?} ]$$

$$\text{?} \text{indicates text missing or illegible when filed}$$

and when a loudspeaker driving signal to obtain an optimum sound field in the meaning of least squares is defined as follows,

\hat{d}

the loudspeaker driving signal can be obtained as

$$\hat{d} = arg {min}_{d} {\vert P - Gd \vert}^{2} .$$

In the present example, processing in consideration of an error in estimation of a position may be performed.

For example, in a case where an error in estimation of a position of a loudspeaker which the l-th UAV among a plurality of UAVs has is large, since it is anticipated that an error in sound field reproduction is increased due to a driving signal dₗ of the l-th loudspeaker, it is desirable that contribution of the driving signal dₗ of the loudspeaker be decreased. Therefore, as shown below, a regularization term is added to the driving signal.

$$\hat{d} = arg {min}_{d} {\vert P - Gd \vert}^{2} + λ {\vert Ad \vert}^{2}$$

Here, λ is a parameter which determines strength of regularization, and A represents a diagonal matrix which has a weight aₗ, which determines relative strength of the regularization for the loudspeaker l, as a diagonal component. For example, in a case where an error in estimation of a position of a third UAV 10C is large, a value of a component of the UAV 10C in A is made large, thereby allowing contribution of a driving signal of the UAV 10C to be decreased.

A solution of this optimization problem is obtained as shown below.

$$\hat{d} = {( {G}^{H} G + λ A )}^{- 1} GP$$

The above-described processing is performed by the audio signal generation unit 201A, thereby generating the audio signals reproduced by the UAVs.

### (Fourth Processing Example)

A fourth processing example is an example in which sound field reproduction is performed by spherical harmonics expansion in which a region where the sound field reproduction is performed is designated. In the above-described mode matching, it is expected that one point is designated as the control point and an order is determined in the mode region for control, thereby smoothly reproducing the periphery of the control point, and a control region is not directly designated. In contrast to this, in the present example, a region V is explicitly controlled, thereby obtaining driving signals of loudspeakers of UAVs.

When a desired sound field is defined as p(r) (note that r is a three-dimensional vector), a transfer function from a loudspeaker l up to a point r within a control region, which is position information in the present example, is defined as G(r|rₗ), g(r)=[G(r|r₁), G(r|r₂) . . . G(r|r_{L})]^{T} is defined, and a driving signal of the loudspeaker to obtain an optimum sound field within the region V is defined as follows,

\hat{d}

a loudspeaker driving signal can be obtained as d(ω) which minimizes a loss function J shown below.

$$J = {\int }_{r ∈ V} {\vert p ( r ) - g ( r ) d \vert}^{2} dr$$

Since the above-described formula is shown by a space region, conversion is made from the space region to a mode region, and an order of the spherical harmonics function is aborted at the Nth order, the loss function J can be thereby approximated to

$$J \approx {( Cd - b )}^{H} W ( Cd - b ) ,$$

but

$$C = [ \begin{matrix}{c}_{0 , 1}^{0} & ⋯ & {c}_{0 , L}^{0} \\ ⋮ & ⋱ & ⋮ \\ {c}_{N , 1}^{N} & ⋯ & {c}_{N , L}^{N}\end{matrix} ]$$

$$W = [ \begin{matrix}{w}_{00 , 00} & ⋯ & {w}_{00 , NN} \\ ⋮ & ⋱ & ⋮ \\ {w}_{NN , 00} & ⋯ & {w}_{NN , NNL}\end{matrix} ]$$

$$w \text{?} = {\int }_{r ∈ V} \text{?} ( r ) {φ}_{{n}^{′} {m}^{′}} ( r ) dr$$

$$\text{?} \text{indicates text missing or illegible when filed}$$

Here, ϕₙ is a basis function which can be represented by the following formula.

$${φ}_{nm} ( r ) = {j}_{n} ( kr ) {Y}_{n}^{m} ( θ , ψ )$$

In the above formula, jₙ (kr) is a spherical Bessel function, Yₙ^{m} is spherical harmonics, and cₘₗ and bₗ are expansion coefficients of G(r|rl) and p(r) by a prescribed function ϕₙ.

In the present example, processing in consideration of an error in estimation of a position may be performed.

In a case where an error in estimation of a position of the l-th loudspeaker is large, since it is anticipated that an error in sound field reproduction due to a driving signal dₗ of the loudspeaker l, it is desirable that contribution of the driving signal dₗ be decreased. Therefore, as shown in the following formula 3, a regularization term is added to a loudspeaker driving signal.

$$J \approx {( Cd - b )}^{H} W ( Cd - b ) + λ {\vert Ad \vert}^{2} \qquad [ Formula 3 ]$$

In the formula 3, A is a diagonal matrix which has a weight aₗ, which determines strength of regularization for the loudspeaker l, as a diagonal component. Large regularization can be imposed on the loudspeaker l whose error in the estimation of the position is large. An optimum solution in the formula 3 is obtained as shown below.

$$\hat{d} = {( {C}^{H} WC + λ A )}^{- 1} {C}^{H} Wb$$

In a mode region, minimization of an error within a certain region V_{q} can be approximated in the formula 3 as shown below.

$$\hat{d} = arg {min}_{d} {\sum }_{q = 1}^{Q} {\int }_{r ∈ {V}_{q}} {\vert p - g ( r ) d \vert}^{2} + λ {\vert Ad \vert}^{2}$$

The above-described processing is performed by the audio signal generation unit 201A, thereby generating the audio signals reproduced by the UAVs.

### [Example of Reproduced Sound Field]

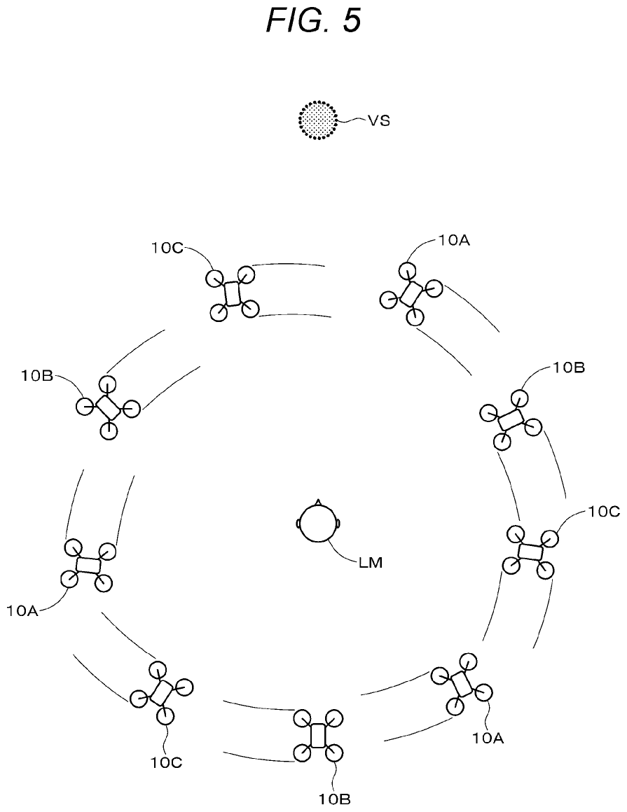

As one example of a designing method of a reproduced sound field, it is considered that irrespective of movement of an UAV 10, sound field reproduction is performed. For example, as schematically illustrated in FIG. 5, while three UAVs (UAV 10A to 10C) move around a listener LM, a localization position of a virtual sound source VS can be fixed in a predetermined position in a space. This sound field reproduction can be realized by fixing a coordinate system in the above-described formula 1 and formula 2 in the space and calculating loudspeaker driving signals of the UAVs while position information of the UAVs is updated. Specifically, the loudspeaker driving signals are obtained while values of L described in the first processing example and (rₗ, θₗ, ϕₗ) described in the second processing example are updated, thereby allowing a sound field according to the present example to be reproduced. By the sound field reproduction according to the present example, for example, in a case where evacuation guidance is conducted by sound by using the UAVs 10, while the UAVs 10 are changing positions in order to avoid obstacles and flying, a sound field where sound is invariably reproduced from an appropriate arrival direction (for example, a direction of an emergency exit) can be realized.

As other example of the designing method of the reproduced sound field, by setting the coordinate system in the above-described formula 1 and formula 2 in such a way as to be in conjunction with a position and a direction of a specific UAV, it is made possible to move the position of the virtual sound source VS in accordance with movement of the above-mentioned specific UAV. For example, by fixing the coordinate system to a certain UAV and moving and rotating the UAV group which includes the above-mentioned specific UAV without deforming formation of the UAV group, the virtual sound source VS can also be parallelly moved and rotated in accordance with the movement of the UAV group.

### [Sound Field Designing Tool]

According to the present disclosure, for example, a tool for designing a sound field for creators is provided. This tool is, for example, a tool which performs displaying of limitation of a sound field which can be designed and accuracy in accordance with moving speeds of the UAVs 10.

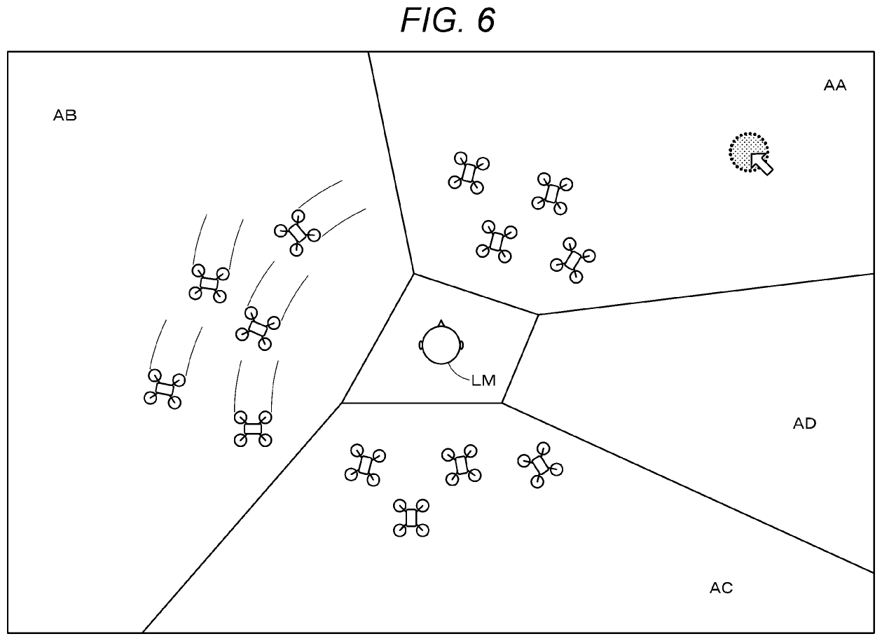

For example, considered is a situation where a creator previously designs the movement of the UAV group as in a case where the UAV group which includes the plurality of UAVs is used for a show or other case. In a case where the sound field reproduction is performed by the plurality of UAVs, a creator also designs the sound field by using the tool. When the creator makes this designing, as illustrated in FIG. 6, on a sound field designing tool with which the virtual sound source VS is located on a graphical user interface (GUI), reproduction accuracy of the virtual sound source VS can be presented to a user in accordance with arrangement of the UAVs. In an example illustrated in FIG. 6, a listener LM is displayed in a substantially center. In addition, on the GUI illustrated in FIG. 6, information that a predetermined space region AA and space region AC are regions, in each of which reproduction accuracy is high, since the movement of the UAV group is small; information that other space region AB is a region in which reproduction accuracy is low since the movement of the UAV group is large and the plurality of UAVs is densely present; and information that other space region AD is a region in which a reproduction region is narrow since the UAVs are only sparsely present can be visually presented to a user. In addition, on the basis of the accuracy of the above-described sound field reproduction, locating the virtual sound source VS may be forbidden on the tool. For example, it may be arranged on the GUI that the virtual sound source VS cannot be located in a place where the accuracy of the sound field reproduction is low (for example, the space region AD). Thus, mismatching between the sound field on the tool which a creator designs and the sound field actually reproduced by using the UAVs can be prevented.

### [Relocation and Increase/Decrease in Number of UAVs]

In the embodiment of the present disclosure, the UAVs may be relocated and a number of UAVs may be increased or decreased. The positions of the UAVs 10 are relocated so as to optimize the reproduced sound field (as a more specific example, wavefronts to realize the desired sound field).

Considered is a situation where previous arrangement of optimum UAVs 10 and designing of a reproduced sound field cannot be made as in case where wavefronts reproduced are dynamically determined in accordance with surrounding circumstances or other case. As the above-mentioned situation, supposed is a situation where in accordance with a position of a listener who moves, the position of the reproduced sound field is changed by the UAVs 10; a situation where in accordance with a number of persons to whom a dynamically changing reproduced sound field is desired to be delivered, a range of the reproduced sound field is changed; a situation where in accordance with gesture or movement of a person, the reproduced sound field such as the position of the virtual sound source is changed; or other situation. In a case where in the above-described situation, it is determined by the master device 20 that in order to reproduce the desired sound field at sufficient accuracy, a number of UAVs 10 is small, a UAV 10 or UAVs 10 may be added by control performed by the master device 20 or the UAVs 10 may be relocated in optimum positions to reproduce the desired sound field. For example, the control is made so as to increase density of UAVs 10 in a virtual sound source direction. In order to obtain the arrangement of the UAVs 10, for example, the technology described in “S. Koyama, et al., “Joint source and sensor placement for sound field control based on empirical interpolation method”, Proc. IEEE ICASSP, 2018.E” can be applied.

### Modified Example

Hereinbefore, although the embodiment of the present disclosure is described, the present disclosure is not limited to the above-described embodiment, and various modifications can be made without departing from the spirit of the present disclosure.

The master device in the above-described embodiment may be a device which remotely controls the UAVs. In addition, one or a plurality of UVAs among the plurality of UAVs may function as the master device, that is, the information processing apparatus. In other words, one or the plurality of UAVs among the plurality of UAVs may have the audio signal generation unit or audio signal generation units and audio signals generated by the audio signal generation unit or audio signal generation units may also be transmitted to the other UAVs. In addition, the master device 20 may be a server device on a cloud or the like.

The above-described calculation in each of the processing examples is one example, the processing in each of the processing examples may be realized other calculation. In addition, the processing in each of the above-described processing examples may be independently performed or may be performed together with other processing. In addition, the configuration of each of the UAVs is also one example, and the heretofore known configuration may be added to the configuration of each of the UAVs in the embodiment. In addition, the number of the UAVs can be appropriately changed.

The present disclosure can also be realized by an apparatus, a method, a program, a system, and the like. For example, a program which performs the function described in the above-described embodiment can be downloaded, and an apparatus which does not have the function described therein downloads and install the program, thereby making it possible to perform the control described in the embodiment on the apparatus. The present disclosure can also be realized by a server which distributes the program described above. In addition, the matters described in the embodiment and the modified example can be appropriately combined. In addition, contents of the present disclosure are not limitedly interpreted by the effect exemplified in the present description.

The present disclosure can also adopt the below-described configuration.
(1)

An information processing apparatus including

an audio signal generation unit which generates an audio signal reproduced from a loudspeaker on the basis of position information of each of a plurality of unmanned aerial vehicles, each of the unmanned aerial vehicles having the loudspeaker.
(2)

The information processing apparatus according to (1), in which

the audio signal generated by the audio signal generation unit is an audio signal which forms a sound field.
(3)

The information processing apparatus according to (2), in which

the audio signal generation unit generates the audio signal by VBAP.
(4)

The information processing apparatus according to (2) or (3), in which

the audio signal generation unit generates the audio signal by wavefront synthesis.
(5)

The information processing apparatus according to any one of (2) to (4), in which

the sound field is a sound field which is fixed in a space.
(6)

The information processing apparatus according to any one of (2) to (4), in which

the sound field is a sound field which changes in conjunction with movement of a predetermined unmanned aerial vehicle.
(7)

The information processing apparatus according to any one of (1) to (6), in which

the audio signal generation unit performs processing in accordance with certainty of position information of the predetermined unmanned aerial vehicle.
(8)

The information processing apparatus according to (7), in which

by weighting and adding a first loudspeaker gain and a second loudspeaker gain, the first loudspeaker gain calculated on the basis of position information of a plurality of unmanned aerial vehicles which include the predetermined unmanned aerial vehicle, the second loudspeaker gain calculated on the basis of position information of a plurality of unmanned aerial vehicles which do not include the predetermined unmanned aerial vehicle, the audio signal generation unit calculates a third loudspeaker gain and generates the audio signal by using the third loudspeaker gain.
(9)

The information processing apparatus according to (7), in which

by adding, to the audio signal, a regularization component in accordance with the certainty of the position information, the audio signal generation unit generates the audio signal reproduced from the loudspeaker.
(10)

The information processing apparatus according to any one of (7) to (9), in which

the certainty of the position information is determined in accordance with a moving speed of the predetermined unmanned aerial vehicle.
(11)

The information processing apparatus according to any one of (1) to (10), in which

the information processing apparatus is any one of the plurality of unmanned aerial vehicles.
(12)

The information processing apparatus according to any one of (1) to (10), in which

the information processing apparatus is an apparatus which is different from the plurality of unmanned aerial vehicles.
(13)

An information processing method including

generating, by an audio signal generation unit, an audio signal reproduced from a loudspeaker on the basis of position information of each of a plurality of unmanned aerial vehicles, each of the unmanned aerial vehicles having the loudspeaker.
(14)

A program which causes a computer to execute an information processing method including

generating, by an audio signal generation unit, an audio signal reproduced from a loudspeaker on the basis of position information of each of a plurality of unmanned aerial vehicles, each of the unmanned aerial vehicles having the loudspeaker.

### REFERENCE SIGNS LIST

1 Reproduction system
10A to 10D UAV
20 Master device
201A Audio signal generation unit

1. An information processing apparatus comprising
an audio signal generation unit which generates an audio signal being reproduced from a loudspeaker on a basis of position information of each of a plurality of unmanned aerial vehicles, each of the unmanned aerial vehicles having the loudspeaker.

2. The information processing apparatus according to claim 1, wherein
the audio signal being generated by the audio signal generation unit is an audio signal which forms a sound field.

3. The information processing apparatus according to claim 2, wherein
the audio signal generation unit generates the audio signal by VBAP.

4. The information processing apparatus according to claim 2, wherein
the audio signal generation unit generates the audio signal by wavefront synthesis.

5. The information processing apparatus according to claim 2, wherein
the sound field is a sound field which is fixed in a space.

6. The information processing apparatus according to claim 2, wherein
the sound field is a sound field which changes in conjunction with movement of a predetermined unmanned aerial vehicle.

7. The information processing apparatus according to claim 1, wherein
the audio signal generation unit performs processing in accordance with certainty of position information of the predetermined unmanned aerial vehicle.

8. The information processing apparatus according to claim 7, wherein
by weighting and adding a first loudspeaker gain and a second loudspeaker gain, the first loudspeaker gain being calculated on a basis of position information of a plurality of unmanned aerial vehicles which include the predetermined unmanned aerial vehicle, the second loudspeaker gain being calculated on a basis of position information of a plurality of unmanned aerial vehicles which do not include the predetermined unmanned aerial vehicle, the audio signal generation unit calculates a third loudspeaker gain and generates the audio signal by using the third loudspeaker gain.

9. The information processing apparatus according to claim 7, wherein
by adding, to the audio signal, a regularization component in accordance with the certainty of the position information, the audio signal generation unit generates the audio signal being reproduced from the loudspeaker.

10. The information processing apparatus according to claim 7, wherein
the certainty of the position information is determined in accordance with a moving speed of the predetermined unmanned aerial vehicle.

11. The information processing apparatus according to claim 1, wherein
the information processing apparatus is any one of the plurality of unmanned aerial vehicles.

12. The information processing apparatus according to claim 1, wherein
the information processing apparatus is an apparatus which is different from the plurality of unmanned aerial vehicles.

13. An information processing method comprising
generating, by an audio signal generation unit, an audio signal being reproduced from a loudspeaker on a basis of position information of each of a plurality of unmanned aerial vehicles, each of the unmanned aerial vehicles having the loudspeaker.

14. A program which causes a computer to execute an information processing method including
generating, by an audio signal generation unit, an audio signal being reproduced from a loudspeaker on a basis of position information of each of a plurality of unmanned aerial vehicles, each of the unmanned aerial vehicles having the loudspeaker.
